(19) United States
(12) Patent Application Publication
(10) Pub. No.: US 2006/0143363 A1
(43) Pub. Date: Jun. 29, 2006

(54) Module interface handler for controller area network (CAN) communication module

(76) Inventor: Peter Steffan, Volkenschwand (DE)

Correspondence Address: TEXAS INSTRUMENTS INCORPORATED, P O BOX 655474, M/S 3999, DALLAS, TX, 75265, US

(21) Appl. No.: 11/314,993

(22) Filed: Dec. 21, 2005

(30) Foreign Application Priority Data
Dec. 23, 2004 (DE) 10 2004 062211.6

(51) Int. Cl. G06F 12/14

(52) U.S. Cl. 711/100

(57) ABSTRACT

A CAN communication module (10) comprises a message RAM (16), a status and control register set (18, 20), a CAN bus interface, a module interface for communication with a central processing unit (CPU) in a connected device and a CAN message handler (14). The module interface includes a dedicated module interface handler (12) with a write transfer register set (24), a read transfer register set (26) and a state machine (34). The write and read transfer register sets are connected to a peripheral bus (28) for communication with the central processor unit of the connected device and with an internal bus (30) for communication with the message RAM and with the status and control register set. The state machine is connected to the CAN message handler to selectively disable the CAN message handler when a write or read access is requested by the central processor unit of the connected device.

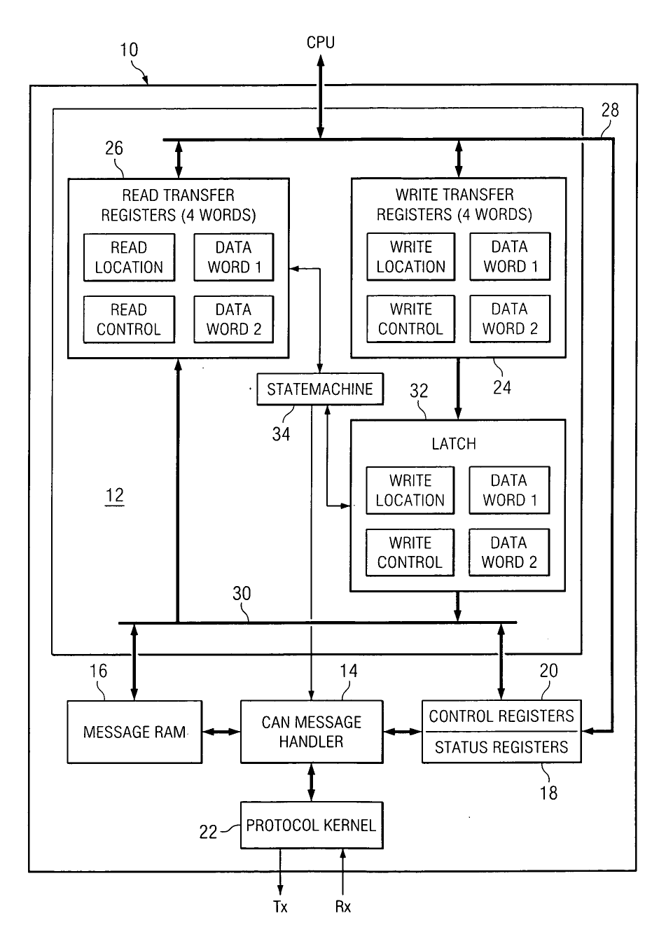

### TECHNICAL FIELD OF THE INVENTION

The technical field of this invention is a module interface handler for a Controller Area Network (CAN) communication module.

### BACKGROUND OF THE INVENTION

In a Controller Area Network (CAN), each node is connected to the serial CAN bus through an associated CAN communication module. The CAN communication module is the link between the CAN bus with its communication in accordance with the CAN protocol and a connected device. The connected device has a controller with a central processing unit (CPU) and a bus connected to the communication module through its module interface. Messages to be exchanged between the CAN bus and the CPU are buffered in a message RAM, also referred to as “Mailbox” RAM. The conditions at the message RAM and at the registers of the module interface must be monitored to avoid any read/write conflicts.

Conventionally, a free running CAN message handler with a state machine performs all functions concerning safe message handling on the side of the CAN bus. On the side of the CPU, the module interface allows direct access of the CPU to the registers of the module and to the message RAM. In this configuration, the problem of possible simultaneous accesses of the CPU and of the CAN message handler to the same location in the registers or in the message RAM must be resolved. The CPU must ensure proper data access. This task can impose heavy load on the CPU. Depending on the location to be accessed, special modes must be entered, dedicated status bits must be polled or even parts of the CAN module need to be disabled in order to ensure a safe data read or write operation.

### SUMMARY OF THE INVENTION

The present invention provides a CAN communication module that comprises a message RAM, a status and control register set, a CAN bus interface, a module interface for communication with a CPU in a connected device and a CAN message handler.

A dedicated module interface handler in the module interface fully controls the read and write accesses to the modules register set and to the message RAM. The dedicated module interface handler includes a write transfer register set, a read transfer register set and a state machine. The write and read transfer register sets are connected to a peripheral bus for communication with the CPU of the connected device, an internal bus for communication with the message RAM and the status and control register set. The state machine is connected to the CAN message handler to selectively disable the CAN message handler when a write or read access is requested by the CPU of the connected device. The read transfer registers are available for the read access from the message RAM and from the status and control register set. For read access, the CPU requests the data from a particular location by writing that location into a read location register in the read transfer register set. The state machine of the module interface handler ensures a safe data read from the required location by disabling the CAN message handler of the module so that data cannot change while being read. Similarly, the write transfer registers are available for write access to the message RAM and to the status and control register set. For write access, the CPU provides the data to be written and the write location to the dedicated write transfer registers. The state machine in the module interface handler then ensures a safe data write to the required location by disabling the CAN message handler of the module so that data only partly transferred will not be overwritten. Accordingly, the CPU of the connected device is relieved from the task of ensuring proper data access.

In a preferred embodiment, the write transfer register set is followed by a latch register set. Data provided from the CPU to the write transfer registers are latched in the latch register set so that the write transfer registers are available for a new write operation while the previously provided data are being written to the message RAM or to the status and control registers, thereby enhancing the data write throughput from the CPU.

Further advantages and features of the invention will become apparent from the following description of a preferred embodiment with reference to the appending drawings.

### BRIEF DESCRIPTION OF THE DRAWINGS

These and other aspects of this invention are illustrated in the drawings, in which:

The FIGURE illustrates a schematic block diagram of the inventive CAN communication module.

### DETAILED DESCRIPTION OF PREFERRED EMBODIMENTS

The FIGURE shows a CAN communication module 10 which has a module interface for 32 bit wide parallel communication with a central processing unit CPU in a connected device and which has a CAN bus interface for serial communication with a CAN bus. CAN communication module 10 comprises the following blocks: a module interface handler 12; a CAN message handler 14; a message RAM 16; status registers 18; control registers 20; and a protocol kernel 22. Module interface handler 12 is part of the module interface and protocol kernel 22 is part of the CAN bus interface.

Module interface handler 12 includes a write transfer register set 24 and a read transfer register set 26. Both register sets 24 and 26 are four word registers and each include two data words, a write location and a write control. In the preferred embodiment 32 bit words are used. The central processing unit CPU is connected to write transfer register set 24, read transfer register set 26 and status registers 18 via a peripheral bus 28. Read transfer register set 26 and write transfer register set 24 are further connected to status registers 18, control registers 20 and message RAM 16 via an internal bus 30. Module interface handler 12 further comprises a latch register set 32, which is a four word register similar to write transfer register set 24 and read transfer register set 26, and a state machine 34 which is connected to read transfer register set 26, latch register set 32 and CAN message handler 14.

CAN message handler 14 is connected to message RAM 16, protocol kernel 22, control register 20 and status registers 18. Protocol kernel 22 is connected to the CAN bus.

If data is to be written from the CPU to CAN communication module 10, the CPU accesses write transfer register 24 directly via peripheral bus 28 and writes first data word 1 and then data word 2. Next, the write control is written, which controls i.e. byte, half word or word access. Lastly, the write location register is written. As soon as this finishes, the contents of write transfer register 24 is latched to latch register set 32, which is connected to state machine 34. State machine 34 disables CAN message handler 14 (after finishing an ongoing action) to avoid any conflict while transferring the contents of latch register set 32 to message RAM 16, control registers 20 or status registers 18 via internal bus 30. With this approach, data being partly transferred will not be overwritten. As write transfer register 24 is latched, the CPU can start with the setup of write transfer register 24 for a new write access before the data is actually written into the dedicated CAN module location. This allows for a high frequency CPU write.

If data is to be read from CAN communication module 10 to the CPU, the CPU writes the location from where the data is to be read into the read location register of read transfer register set 26. The requested location is read by state machine 34 and transferred to CAN message handler 14, thereby interrupting CAN message handler 14 and ensuring a safe data read from the required location. As CAN message handler 14 is disabled during the read process, data cannot change during read. The data is transferred via the internal bus 30 directly to read transfer register set 26. When the data transfer is accomplished, the availability of the data is indicated by a receive transfer ready flag. Optionally an interrupt can be generated.

The CPU can access status registers 18 via peripheral bus 28. Status registers 18 are memory mapped to allow the CPU to read the information contained therein directly without passing by CAN message handler 14. This allows an effective polling of CAN module status flags.

What is claimed is:

1. A CAN communication module (10), comprising:
a message RAM (16);
a status and control register set (18, 20);
a CAN bus interface;
a module interface for communication with a central processing unit (CPU) in a connected device;
a CAN message handler (14);
wherein the module interface includes a dedicated module interface handler (12) with a write transfer register set (24), a read transfer register set (26) and a state machine (34), the write and read transfer register sets being connected to a peripheral bus (28) for communication with the central processor unit of the connected device and with an internal bus (30) for communication with the message RAM (16) and with the status and control register set (18,20); and
wherein the state machine (34) is connected to the CAN message handler (14) to selectively disable the CAN message handler (14) when a write or read access is requested by the central processor unit of the connected device.

2. The communication module (10) according to claim 1, wherein:
the write transfer register set (24) is followed by a latch register set (32).

3. The communication module according to claim 1, wherein:
the status register (18) is connected to the peripheral bus (28).
